(19) United States
(12) Patent Application Publication
(10) Pub. No.: US 2017/0195853 A1
(43) Pub. Date: Jul. 6, 2017

(54) MOBILE DEVICE, METHOD FOR CONTROLLING MOBILE DEVICE, AND NON-TRANSITORY STORAGE MEDIUM

(71) Applicant: KYOCERA Corporation, Kyoto-shi, Kyoto (JP)

(72) Inventors: Shigeki TANABE, Yokohama-shi, Kanagawa (JP); Hideki MORITA, Yokohama-shi, Kanagawa (JP); Isao MASUIKE, Machida-shi, Tokyo (JP); Shinya SAITO, Kawasaki-shi, Kanagawa (JP)

(21) Appl. No.: 15/313,102

(22) PCT Filed: May 26, 2015
(86) PCT No.: PCT/JP2015/065114

§ 371 Date: Nov. 22, 2016

(30) Foreign Application Priority Data
May 27, 2014 (JP) 2014-109418

(51) Int. Cl. H04W 4/02; G01P 15/18; G01P 15/03; G01P 15/08; G01P 15/00; G01C 19/5691; G01C 21/18

(52) U.S. Cl. CPC H04W 4/027; G01C 19/5691; G01P 15/18; G01C 21/18; G01P 15/08; G01P 15/001; G01P 15/005; G01P 15/034; G01P 2015/082

(57) ABSTRACT

A mobile device, comprises an acceleration sensor configured to detect accelerations in three axes, and at least one controller configured to control functions based on the accelerations in the three axes of the acceleration sensor, wherein based on accelerations in two axes out of the three axes, the at least one controller changes an offset of an acceleration in the remaining one axis.

### CROSS-REFERENCE TO RELATED APPLICATION

This application is a national stage of PCT International Application No. PCT/JP2015/065114 filed in Japan on May 26, 2015, which claims priority to and incorporates by reference the entire contents of Japanese Patent Application No. 2014-109418 filed in Japan on May 27, 2014.

### FIELD

The present disclosure relates to a mobile device, a method for controlling a mobile device, and a non-transitory storage medium.

### BACKGROUND

Some cellular phones include an acceleration sensor. This acceleration sensor is used for various kinds of control of a cellular phone. Japanese Patent Application Laid-open No. 2006-107657 describes a cellular phone that uses an acceleration sensor for control, for example. This cellular phone cannot execute appropriate control if the accuracy of the acceleration sensor is low.

### SUMMARY

A mobile device, a method for controlling the mobile device, and a non-transitory storage medium are disclosed.

According to one aspect, there is provided a mobile device, comprising an acceleration sensor configured to detect accelerations in three axes, and at least one controller configured to control functions based on the accelerations in the three axes of the acceleration sensor, wherein based on accelerations in two axes out of the three axes, the at least one controller changes an offset of an acceleration in the remaining one axis.

According to one aspect, there is provided a control method of a mobile device that controls functions based on accelerations in three axes of an acceleration sensor, the control method comprising, based on accelerations in two axes out of the three axes, changing an offset of an acceleration in the remaining one axis.

According to one aspect, there is provided a non-transitory storage medium that stores a control program of a mobile device that controls functions based on accelerations in three axes of an acceleration sensor, the control program comprising, based on accelerations in two axes out of the three axes, changing an offset of an acceleration in the remaining one axis.

### BRIEF DESCRIPTION OF THE DRAWINGS

FIG. 1 is a perspective schematic view of an appearance of a smartphone according to an embodiment.

FIG. 2 is a front schematic view of the appearance of the smartphone according to the embodiment.

FIG. 3 is a rear schematic view of the appearance of the smartphone according to the embodiment.

FIG. 4 is a block schematic view of a configuration of the smartphone according to the embodiment.

FIG. 5 is a diagram schematically illustrating a detection result of an acceleration sensor.

FIG. 6 is a screen example of the smartphone according to the embodiment.

FIG. 7 is a screen example of the smartphone according to the embodiment.

FIG. 8 is a diagram of an example of a control flow that the smartphone according to the embodiment performs.

### DETAILED DESCRIPTION OF THE PREFERRED EMBODIMENTS

The following describes a plurality of embodiments for performing a mobile device of the present disclosure in detail with reference to the accompanying drawings. The following illustrates and describes a smartphone as an example of the mobile device.

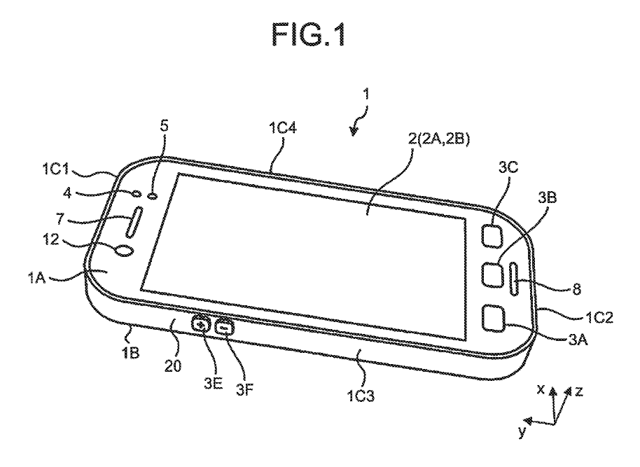

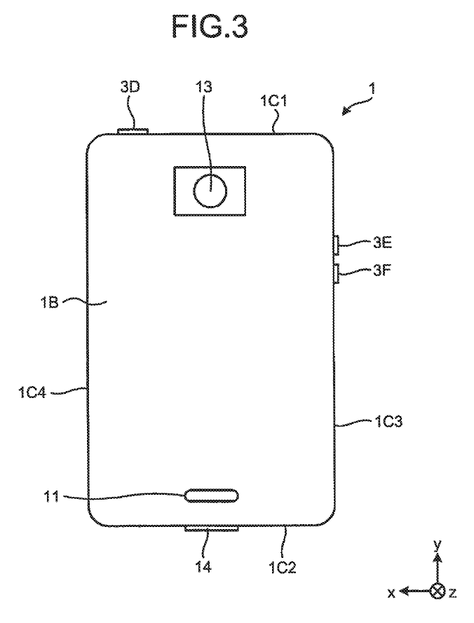

The following describes an appearance of a smartphone 1 according to one of the embodiments with reference to FIG. 1 to FIG. 3. The smartphone 1 includes a housing 20. The housing 20 includes a front face 1A, a rear face 1B, and side faces 1C1 to 1C4. The front face 1A is a front face of the housing 20. The rear face 1B is a rear face of the housing 20. The side faces 1C1 to 1C4 are side faces that connect the front face 1A and the rear face 1B. In the following description, the side faces 1C1 to 1C4 may collectively be referred to as a side face 1C without specifying the side face/faces.

The smartphone 1 includes a touch screen display 2, buttons 3A to 3C, an illuminance sensor 4, a proximity sensor 5, a receiver 7, a microphone 8, and a camera 12 on the front face 1A. The smartphone 1 includes a speaker 11 and a camera 13 on the rear face 1B. The smartphone 1 includes buttons 3D to 3F and a connector 14 on the side face 1C. In the following description, the buttons 3A to 3F may collectively be referred to as a button 3 without specifying the button/buttons.

The touch screen display 2 includes a display 2A and a touch screen 2B. The display 2A includes a display device such as a liquid crystal display, an organic electro-luminescence panel, or an inorganic electro-luminescence panel. The display 2A can display objects. The objects include letters, images, symbols, and figures.

The touch screen 2B detects contact with the touch screen 2B by a finger, a stylus pen, or the like. The touch screen 2B can detect positions at which a plurality of fingers, a plurality of stylus pens, or the like have been brought into contact with the touch screen 2B.

The detection system of the touch screen 2B can employ a plurality of systems. Examples of the systems include an electrostatic capacitance system, a resistance film system, a surface acoustic wave system (or an ultrasonic system), an infrared system, an electromagnetic induction system, and a load detection system. The electrostatic capacitance system can detect the contact and approach of the finger, the stylus pen, or the like. In the following description, the finger, the stylus pen, or the like the contact of which is detected by the touch screen 2B may be referred to simply as a “finger” in order to simplify the description.

The smartphone 1 determines type of a gesture based on contact detected by the touch screen 2B, a position at which the contact has been made, a time during which the contact has been made, and a temporal change in a position at which the contact has been made. The gesture is an operation performed on the touch screen display 2. Examples of the gesture determined by the smartphone 1 include touch, long touch, release, swipe, tap, double tap, long tap, drag, flick, pinch, and spread.

The smartphone 1 performs operations in accordance with these gestures determined via the touch screen 2B. The smartphone 1 performs operations based on the gesture and can thereby achieve operability that is intuitive and easy-to-use for a user. The smartphone 1 performs operations corresponding to a screen displayed on the touch screen display 2 in accordance with the determined gesture. The operation of the smartphone 1 varies in accordance with the determined gesture and the displayed screen.

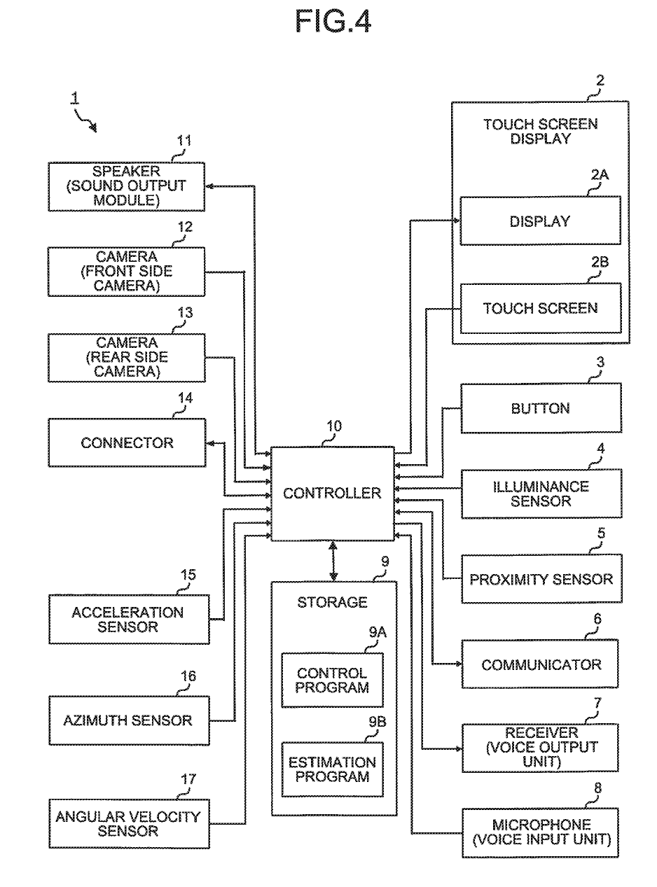

FIG. 4 is a block diagram of a configuration of the smartphone 1. The smartphone 1 includes the touch screen display 2, the button 3, the illuminance sensor 4, the proximity sensor 5, a communicator 6, the receiver 7, the microphone 8, a storage 9, a controller 10, the speaker 11, the camera 12, the camera 13, the connector 14, an acceleration sensor 15, an azimuth sensor 16, and an angular velocity sensor 17.

The touch screen display 2 includes the display 2A and the touch screen 2B. The display 2A displays the objects. The touch screen 2B includes a receiving area. The touch screen 2B receives contact to the receiving area as input. In other words, the touch screen 2B detects contact. The controller 10 detects the gesture on the smartphone 1. The controller 10 cooperates with the touch screen 2B to detect the gesture on the touch screen 2B (or the touch screen display 2). The controller 10 cooperates with the touch screen 2B to detect the gesture on the display 2A (or the touch screen display 2).

The button 3 is operated by the user. The button 3 includes a button 3A to a button 3F. The controller 10 cooperates with the button 3 to detect operations on the button. Examples of the operations on the button include, but are not limited to, click, double click, push, and long push.

The buttons 3A to 3C are a home button, a back button, or a menu button, for example. The buttons 3A to 3C may employ touch sensor type buttons. The button 3D is a power-on/power-off button of the smartphone 1, for example. The button 3D may also serve as a sleep/sleep release button. The buttons 3E and 3F are volume buttons, for example.

The illuminance sensor 4 can detect illuminance. The illuminance is intensity, brightness, or the like of light, for example. The illuminance sensor 4 may be used to adjust luminance of the display 2A, for example. The proximity sensor 5 can detect presence of a nearby object in a non-contact manner. The proximity sensor 5 may be used to detect that the touch screen display 2 has approached a face, for example.

The communicator 6 can communicate with another device by wireless communication. Communication systems performed by the communicator 6 include wireless communication standards. Examples of the wireless communication standards include, but are not limited to, cellular phone communication standards such as 2G, 3G, and 4G. Examples of the cellular phone communication standards include, but are not limited to, Long Term Evolution (LTE), Wideband Code Division Multiple Access (W-CDMA), Code Division Multiple Access 2000 (CDMA2000), Personal Digital Cellular (PDC), Global System for Mobile Communications (GSM) (registered trademark), and Personal Handy-phone System (PHS). Examples of the wireless communication standards include, but are not limited to, Worldwide Interoperability for Microwave Access (WiMAX) (registered trademark), IEEE802.11, Bluetooth (registered trademark), Infrared Data Association (IrDA), and Near Field Communication (NFC) (registered trademark). The communicator 6 may support one or more of the communication standards.

The receiver 7 can receive a voice signal transmitted from the controller 10. The receiver 7 can output the received voice signal as a voice. The microphone 8 can convert a voice of a user or the like into a voice signal. The microphone 8 can transmit the converted voice signal to the controller 10. The smartphone 1 may further include a speaker in addition to the receiver 7. The smartphone 1 may further include a speaker in place of the receiver 7.

The storage 9 can store therein computer programs and data. The storage 9 may be used as a work area that temporarily stores therein processing results of the controller 10. The storage 9 may include any storage device such as a semiconductor storage device or a magnetic storage device. The storage 9 may include a plurality of types of storage devices. The storage 9 may include at least an external storage medium such as a memory card or a reading device for a storage medium.

The computer programs stored in the storage 9 include an application executed in the foreground or the background and a control program that supports the operation of the application. The application causes the display 2A to display a screen, for example. The application causes the controller 10 to execute processing responsive to the gesture detected via the touch screen 2B. The control program is an operation system (OS), for example. The application and the control program may be installed in the storage 9 via wireless communication by the communicator 6 or a storage medium.

The storage 9 may store therein a control program 9A and an estimation program 9B, for example. The control program 9A can provide functions about various kinds of control for operating the smartphone 1. The control program 9A controls the communicator 6, the receiver 7, the microphone 8, and the like to implement a telephone conversation, for example. The control program 9A implements changes in screen direction displayed on the display 2A. The estimation program 9B provides a function of estimating an offset occurred in the acceleration sensor 15. The function that the control program 9A provides may be used in combination with a function that the other program such as the estimation program 9B provides.

The controller 10 can integrally control the operation of the smartphone 1. The controller 10 implements various kinds of functions. The controller 10 includes a processor. Examples of the processor include, but are not limited to, a central processing unit (CPU), a micro control unit (MCU), and a field-programmable gate array (FPGA). The controller 10 may be an integrated circuit such as a system-on-a-chip (SoC), in which other components such as the communicator 6 are integrated. The controller 10 may include a combination of a plurality of integrated circuits.

Specifically, the controller 10 executes commands contained in the computer programs stored in the storage 9 while referring to the data stored in the storage 9 as needed, controls the display 2A, the communicator 6, the acceleration sensor 15, the azimuth sensor 16, the angular velocity sensor 17, and the like, and can thereby implement various kinds of functions. The controller 10 executes commands contained in a calculation application stored in the storage 9 and can thereby implement various kinds of functions. The controller 10 can change control in accordance with the detection results of the various kinds of detectors such as the touch screen 2B, the button 3, the acceleration sensor 15, the azimuth sensor 16, and the angular velocity sensor 17.

The camera 12 may photograph an object facing the front face 1A as a front side camera. The camera 13 may photograph an object facing the rear face 1B as a rear side camera.

The connector 14 includes a terminal to which another apparatus is connected. The connector 14 may function as a communication module that causes the smartphone 1 and the other apparatus to communicate with each other via an attachment connected to the connector. The connector 14 may be a general-purpose terminal such as Universal Serial Bus (USB), High-Definition Multimedia Interface (HDMI) (registered trademark), Mobile High-Definition Link (MHL), Light Peak, Thunderbolt, a local area network (LAN) connector, or an earphone/microphone connector. The connector 14 may be an exclusively designed connector such as a Dock connector. Examples of the apparatus to be connected to the connector 14 include, but are not limited to, a charger, an external storage, a speaker, a communication apparatus, and an information processing apparatus.

The acceleration sensor 15 can detect the magnitude and a direction of acceleration acting on the smartphone 1. The acceleration sensor 15 can output the detected magnitude and direction of the acceleration as an acceleration signal. The controller 10 receives the acceleration signal that the acceleration sensor 15 has output. In one embodiment, the acceleration sensor 15 can employ a triaxial type. The triaxial type acceleration sensor 15 may detect accelerations in an X-axial direction, a Y-axial direction, and a Z-axial direction. The triaxial type acceleration sensor can detect the magnitude of the accelerations in the respective axes. The triaxial type acceleration sensor can output the direction of each of the accelerations in the respective axes in a plus or minus value. The triaxial type acceleration sensor can detect the direction of the acceleration based on the magnitude of each of the accelerations in the respective axes.

The acceleration sensor 15 may employ a piezo resistance type, an electrostatic capacitance type, a piezoelectric element (piezoelectric type), a micro electro mechanical system (MEMS) based on a thermal detection type, a servo type that returns to the original state through a feedback current by moving a movable coil, or a strain gauge type, for example.

When the direction of the acceleration is output, the controller 10 can perform control while reflecting moving direction of the smartphone 1, for example. When gravity acting on the smartphone 1 is output as acceleration, the controller 10 can perform control while reflecting a direction of gravity acting on the smartphone 1, for example.

The azimuth sensor 16 can detect azimuth of geomagnetism. The azimuth sensor 16 can output the detected azimuth of geomagnetism. When the azimuth of geomagnetism is output, the controller 10 can perform control while reflecting the azimuth of the smartphone 1, for example. When a change in the azimuth of geomagnetism is output, the controller 10 can perform control while reflecting a change in the azimuth of the smartphone 1, for example.

The angular velocity sensor 17 can detect angular velocity of the smartphone 1. The angular velocity sensor 17 can output the detected angular velocity. When the presence or absence of angular velocity is output, the controller 10 can perform control while reflecting rotation of the smartphone 1, for example.

The output of the acceleration sensor 15, the azimuth sensor 16, and the angular velocity sensor 17 can be used as a combined output of the sensors. When the combined output is used as a motion sensor, the smartphone 1 can execute control by the controller 10 while highly reflecting motion of the device.

The smartphone 1 may reflect at least one of the attitude change of the device, the position change of the device, and the rotation of the device in control. There is provided, as an example of using the attitude change for control, processing to change the display direction of the screen. There is provided, as an example of using the position change for control, processing to update the position of the smartphone 1 at a place where global positioning system (GPS) signals cannot be received. This processing is not limited to be used in the place where GPS signals cannot be received and can also be used in combination with GPS signals in order to increase accuracy of the position. There is provided, as an example of using the rotation for control, processing to update the direction of the smartphone 1 at a place where geomagnetism cannot be detected. This processing is not limited to be used in the place where geomagnetism cannot be detected and can also be used in combination with geomagnetism detection signals in order to increase accuracy of the direction.

The sensors used for the control of the smartphone 1 are not limited to the above-mentioned sensors, and various sensors such as an atmospheric pressure sensor, a temperature sensor, a humidity sensor, and a pressure sensor can be used. The detection results of the various sensors including the azimuth sensor 16 and the angular velocity sensor 17 may be used for the determination of a moving state.

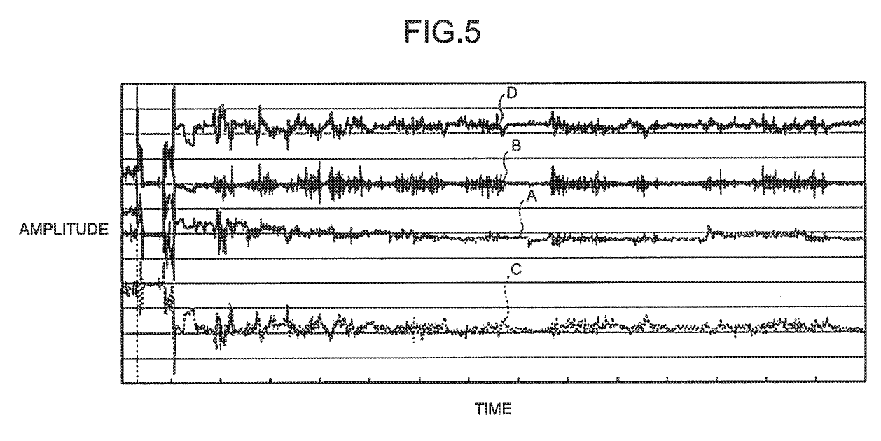

The following describes a control example based on a detection result of the acceleration sensor 15 by the controller 10 with reference to FIG. 5.

As illustrated in FIG. 5, an acceleration signal A in the X-axial direction, an acceleration signal B in the Y-axial direction, an acceleration signal C in the Z-axial direction, and a resultant vector value D obtained by combining the acceleration signals in the triaxial directions are transmitted to the controller 10 as the detection result of the acceleration sensor 15. The controller 10 can log the resultant vector value. The controller 10 analyzes the logged data and can determine a moving state of the smartphone 1. The logged resultant vector may be stored in the storage 9.

The controller 10 determines a state of the smartphone 1 or a moving state of the user of the smartphone 1 by acceleration patterns. In the following description, the state of the smartphone 1 or the moving state of the user of the smartphone 1 may be simply referred to as “the moving state of the smartphone 1” in order to simplify the description. The acceleration patterns are previously stored in the storage 9, for example. One acceleration pattern is associated with one of a plurality of moving states including a stopped state. One acceleration pattern is a change pattern obtained by previously measuring and extracting a characteristic acceleration pattern detected by the acceleration sensor 15 in one of the moving states. Examples of the acceleration pattern include a case in which the smartphone 1 is in a stationary state of being left at rest, a case in which the user of the smartphone 1 is in a state of stopping movement, a case in which the user of the smartphone 1 is in a moving state of moving by walking, a case in which the user of the smartphone 1 is in a moving state of moving while riding on a bicycle, and a case in which the user of the smartphone 1 is in a moving state of moving by means of transportation such as a car or a train.

In one embodiment, the acceleration patterns are previously stored in the storage 9 for the moving states including the stopped state respectively, for example. The acceleration patterns are stored corresponding to the logged data of the resultant vector value. The controller 10 compares the logged data of the resultant vector value with the acceleration patterns to determine the moving state of the smartphone 1.

The controller 10 may determine a case in which magnitude of the acceleration detected by the acceleration sensor 15 is less than a predetermined value to be the stopped state in place of or in addition to a case of determining the stopped state by the acceleration pattern. The controller 10 may determine a case in which the logged data of the resultant vector value does not match any of the moving states to be the stopped state in place of or in addition to a case of determining the stopped state by the acceleration pattern.

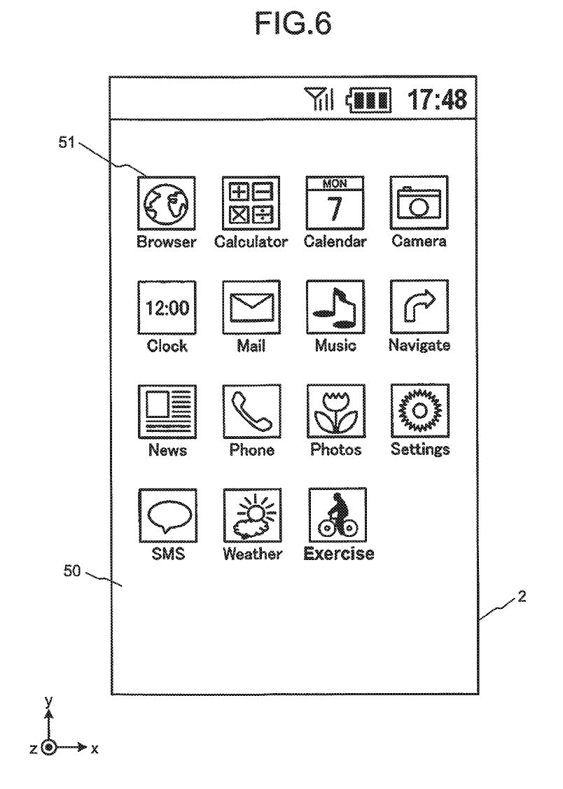

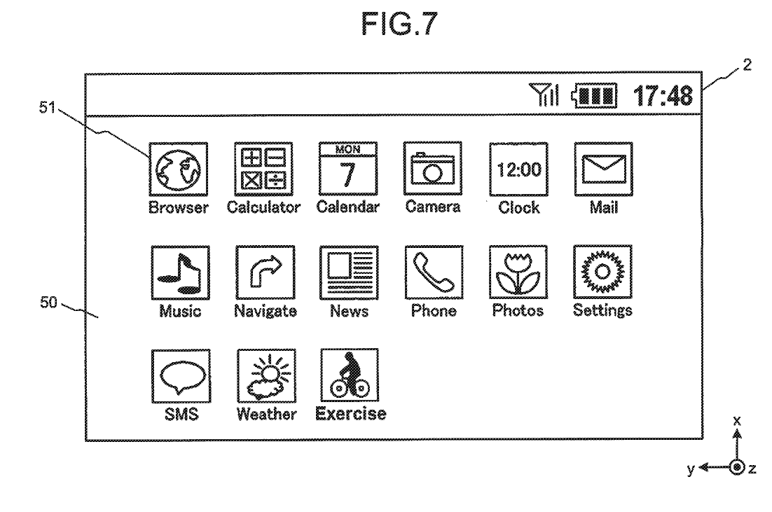

FIGS. 6 and 7 illustrate examples of a home screen displayed on the display 2A of the smartphone 1. The home screen may be referred to as a desktop, a launcher, or an idle screen. The home screen is displayed on the display 2A. The home screen is a screen in which the user can select an application to be executed among the applications installed in the smartphone 1. In this home screen 50, a plurality of icons 51 is arranged. Each of the icons 51 is previously associated with one of the applications installed in the smartphone 1. When detecting a gesture on an icon 51, the smartphone 1 executes an application associated with the icon 51.

When gravity acting on the smartphone 1 is output to the controller 10 as an acceleration, the smartphone 1 can determine orientation of the device relative to the gravity direction. As illustrated in FIGS. 6 and 7, the smartphone 1 can change the display direction of the screen along the gravity direction. FIG. 6 is a screen example displayed when the controller 10 determines that gravity is acting in the minus Y direction. FIG. 7 is a screen example displayed when the controller 10 determines that gravity is acting in the minus X direction. The controller 10 determines that gravity is acting in a direction in which a gravity vector is the greatest in the plus X direction, the minus X direction, the plus Y direction, and the minus Y direction.

The following describes the display direction of the screen. The display direction of the screen is a direction in which the screen is displayed on the display 2A. The display direction of the screen is a direction based on a direction of a letter or image displayed on the display 2A. Based on the letter or image displayed on the display 2A, vertical direction and horizontal direction of the screen can be determined. The vertical direction of the screen is independent of the horizontal direction based on the gravity direction. This independency is obvious from the fact that the screen can be displayed in one of the display direction described above even when gravity is acting only in the Z direction such as a case in which the smartphone 1 is placed horizontally.

As exemplified above, various kinds of control by the controller 10 is performed in the smartphone 1 based on the detection result of the acceleration sensor 15.

In some acceleration sensors, an offset may occur in an output acceleration depending on operating conditions. Examples of causes of the offset in the output acceleration include, but are not limited to, temperature and impact. When the offset occurs in the output acceleration of the acceleration sensor 15, the controller 10 executes various kinds of control based on the acceleration in which the offset occurs. The controller 10 may execute various kinds of control based on the acceleration considering the occurred offset.

The controller 10 can estimate constant of the offset occurred in the acceleration sensor 15. This controller 10 can correct the acceleration of the acceleration sensor based on an estimated value of the offset. This controller 10 executes various kinds of control based on the acceleration with the offset and the estimated value of the offset.

The following describes a method by which the controller 10 estimates the constant of the offset occurring in the acceleration sensor 15 in an example in which an offset occurs in the X direction of the acceleration sensor 15. This example assumes that, in the Y direction and the Z direction of the acceleration sensor 15, no offset occurs, the offset is negligibly small, or the offset is smaller than that in the X direction.

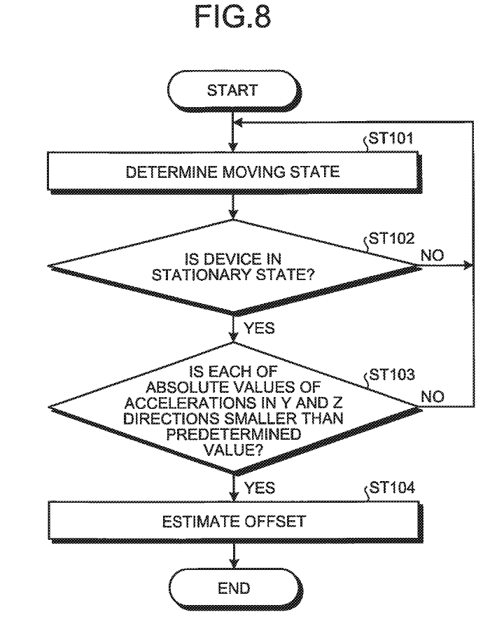

FIG. 8 is a diagram of an example of a control flow that the smartphone 1 performs. FIG. 8 illustrates a control flow that estimates the constant of the offset occurring in the acceleration sensor 15.

First of all, at Step ST101, the smartphone 1 determines the moving state of the device. This determination of the moving state of the device is performed by a fluctuation pattern of the acceleration. If an offset constant occurs in the acceleration sensor 15, the smartphone 1 can determine the moving state of the device with high precision. After determining the moving state of the device at Step ST101, the smartphone 1 proceeds to Step ST102.

At the next Step ST102, the smartphone 1 determines whether the moving state determined at Step ST101 is the stationary state. When it is determined that the moving state of the device is the stationary state (Yes), the smartphone 1 proceeds to Step ST103. When it is determined that the moving state of the device is not the stationary state (No), the smartphone 1 proceeds to Step ST101.

At the next Step ST103, the smartphone 1 determines whether each of absolute values of the accelerations in the Y direction and the Z direction is smaller than a predetermined value. This predetermined value at Step ST103 is set as appropriate depending on accuracy required for the acceleration in the X direction. When each of the absolute values of the accelerations in the Y direction and the Z direction is smaller than the predetermined value (Yes), the smartphone 1 proceeds to the next Step ST104. When each of the absolute values of the accelerations in the Y direction and the Z direction is the predetermined value or more (No), the smartphone 1 proceeds to Step ST101.

At Step ST104, the smartphone 1 estimates an offset occurring in the acceleration sensor 15. The smartphone 1 estimates the offset by causing the controller 10 to perform a computation based on the following equations.

First of all, the controller 10 calculates the supposed value (Xₛᵤₚ) of the acceleration in the X direction based on the following Equation (1). This Equation (1) employs average values (Yₐᵥₑ and Zₐᵥₑ) of the accelerations in the Y direction and the Z direction and gravitational acceleration (V_{g}). As the average value, an average of the acceleration in the latest predetermined period is employed.

±Xₛᵤₚ=\sqrt{v_{g}²−Yₐᵥₑ²−Zₐᵥₑ²} (1)

In this Equation (1), the average (Yₐᵥₑ) of the acceleration in the Y direction and the average (Zₐᵥₑ) of the acceleration in the Z direction are squared. Consequently, when the averages (Yₐᵥₑ and Zₐᵥₑ) are smaller, the accuracy of the supposed value (Xₛᵤₚ) of the acceleration in the X direction is higher. Considering this point, the predetermined value at Step ST103 is set as appropriate depending on the accuracy required for the acceleration in the X direction.

Then, an estimated value (X_{cal}) of the offset occurring in the acceleration sensor 15 is determined based on Equation (2). In this Equation (2), the estimated value (X_{cal}) is calculated considering both cases in which the supposed value (Xₛᵤₚ) of the acceleration calculated by Equation (1) is a positive value and a negative value.

X_{cal}=Xₐᵥₑ±Xₛᵤₚ (2)

Finally, the controller 10 employs, as the estimated value (X_{cal}) of the offset, one of the estimated values calculated based on Equation (2) the absolute value of which is smaller.

By subtracting the estimated value (X_{cal}) of the offset estimated as described above from the acceleration that the acceleration sensor 15 has detected, the smartphone 1 can estimate the acceleration with higher accuracy.

Characteristic examples have been described in order to disclose the present disclosure completely and clearly. However, the accompanying claims should not be limited to the above-described examples and should be configured to embody all modifications and substitutable configurations that those skilled in the art can create within the range of the basic matters disclosed in the present specification.

Part or the whole of the computer programs described to be stored in the storage 9 in FIG. 4 may be downloaded from another apparatus via wireless communication by the communicator 6. Part or the whole of the computer programs described to be stored in the storage 9 in FIG. 4 may be stored in a storage medium that is readable by the reading device included in the storage 9. Part or the whole of the computer programs described to be stored in the storage 9 in FIG. 4 may be stored in a storage medium such as a flash memory, hard disk drive (HDD), a compact disc (CD), a digital versatile disc (DVD), or a Blu-ray (registered trademark) disc (BD) that is readable by a reading device connected to the connector 14.

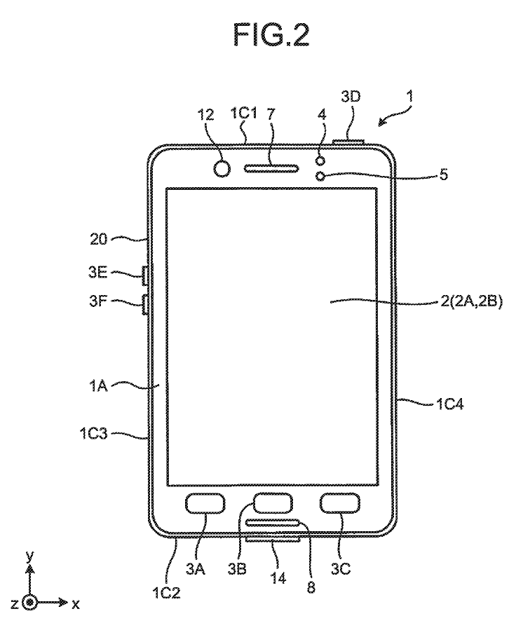

The configuration of the smartphone 1 illustrated in FIG. 4 is an example and may be changed as appropriate within an extent that does not impair essence of the present disclosure. The number and type of the button 3 are not limited to the example in FIG. 2, for example. The smartphone 1 may provide buttons with numeric arrangement, QWERTY arrangement, or the like in place of the buttons 3A to 3C as buttons for operations about the screen, for example. The smartphone 1 may provide only one button or does not provide any button for operations about the screen. Although in the example illustrated in FIG. 4 the smartphone 1 provides two cameras, the smartphone 1 may provide only one camera or does not provide any camera. The illuminance sensor 4 and the proximity sensor 5 may be configured by one sensor.

When an absolute value of a difference between an estimated value newly estimated and an estimated value currently employed is smaller than a predetermined value, the controller 10 may continuously employ the estimated value currently employed without employing the estimated value newly estimated. By continuously employing the estimated value currently employed, updated frequency of the estimated value can be reduced. The smartphone 1 that estimates means of transportation of the user can increase accuracy of determining the means of transportation, for example. When the estimated value is changed, the controller 10 determines that the acceleration that the acceleration sensor 15 has detected has changed. This is because when the estimated value is frequently changed, the controller 10 determines that the acceleration that the acceleration sensor 15 has detected is frequently changed by the change of the estimated value.

In FIG. 8, when it is determined that the device is not in the stationary state (No) at Step ST102, the smartphone 1 is described to return to Step ST101. However, this is not limited thereto. The smartphone 1 may perform a control flow that ends when it is determined that the device is not in the stationary state (No) at Step ST102, for example. The smartphone 1 may perform a control flow that ends when it is determined to be ‘No’ consecutively a predetermined number of times at Step ST102. When these control flows are employed, the smartphone 1 may constantly execute the new control flow, start the execution of the new control flow periodically every predetermined time, execute the new control flow when it becomes a predetermined time, or start the execution of the new control flow on occurrence of a predetermined event. Examples of the predetermined events include an event in which the moving state of the device is expected to be the stationary state or expected to become the stationary state. Examples of the events include an event to start charging, an operation to set the smartphone 1 to the sleep mode, and an operation to end a telephone conversation.

Although the smartphone 1 determines that the device is in the stationary state at Step ST101 and Step ST102 in FIG. 8, this is not limited thereto. The smartphone 1 may determine a case in which amplitude or peak-to-peak of each of the accelerations in the three directions X, Y, and Z is smaller than a predetermined value in place of step ST101 and Step ST102, for example.

Although the example in which only the offset in the X direction of the acceleration sensor 15 is described in embodiments, the smartphone 1 may estimate the offset at least in one direction among the X direction, the Y direction, and the Z direction. When the smartphone 1 estimates the offsets in a plurality of directions, first the offset in one direction that can be estimated in one situation is estimated, and then the offset in other direction that can be estimated in other situation is estimated. The smartphone 1 repeats the calibration of the offsets in each of the directions and can thereby calibrate the offsets in the directions sequentially.

When a control to cause vibration by a vibrator is performed while estimating the offset of the acceleration sensor 15, for example, the smartphone 1 may cancel the control before the vibrator starts to vibrate or cancel the estimation of the offset of the acceleration sensor 15.

The present disclosure can cause an acceleration sensor to function effectively.

1. A mobile device, comprising:
an acceleration sensor configured to detect accelerations in three axes; and
at least one controller configured to control functions based on the accelerations in the three axes of the acceleration sensor, wherein
based on accelerations in two axes out of the three axes, the at least one controller changes an offset of an acceleration in the remaining one axis.

2. The mobile device according to claim 1, wherein
the at least one controller is configured to determine a moving state from a plurality of moving states based on the accelerations, and
when the determined moving state is a predetermined moving state, based on the accelerations in the two axes out of the three axes, the at least one controller is configured to change the offset of the acceleration in the remaining one axis.

3. The mobile device according to claim 1, wherein when each of the accelerations in the two axes out of the three axes is smaller than a predetermined value, based on the accelerations in the two axes, the at least one controller is configured to change the offset of the acceleration in the remaining one axis.

4. The mobile device according to claim 1, wherein the at least one controller is configured to compute the accelerations in the two axes out of the three axes and to compute the offset of the acceleration in the remaining one axis.

5. The mobile device according to claim 1, wherein the acceleration sensor has a characteristic in which the offset occurs in the acceleration due to at least either temperature or impact.

6. A control method of a mobile device that controls functions based on accelerations in three axes of an acceleration sensor, the control method comprising:
based on accelerations in two axes out of the three axes, changing an offset of an acceleration in the remaining one axis.

7. A non-transitory storage medium that stores a control program of a mobile device that controls functions based on accelerations in three axes of an acceleration sensor, the control program comprising:
based on accelerations in two axes out of the three axes, changing an offset of an acceleration in the remaining one axis.
